(19) United States
(12) Patent Application Publication
(10) Pub. No.: US 2005/0060585 A1
(43) Pub. Date: Mar. 17, 2005

(54) Server apparatus

(75) Inventor: Sho Murakoshi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/933,233

(22) Filed: Sep. 3, 2004

(30) Foreign Application Priority Data
Sep. 16, 2003 (JP) 2003-322537

(51) Int. Cl. H04L 9/00

(52) U.S. Cl. 713/201

(57) ABSTRACT

A server apparatus includes a registration table for storing identification codes and access times of clients; a registration-controlling unit for controlling the identification codes in the registration table; an authenticating unit for authenticating the clients with reference to the registration table; and a clock for providing a current access time. When a client submits a registration request, the registration-controlling unit registers the identification code of the client and the current access time in the registration table. When a client submits an access request and when the authenticating unit confirms existence of the identification code of the client in the registration table, the access request is accepted and the access time of the client in the registration table is updated with the current access time. At least one client having no access for a predetermined period is removed from the registration table.

### BACKGROUND OF THE INVENTION

1. Field of the Invention

The present invention relates to server apparatuses used in client/server systems.

2. Description of the Related Art

Recently, many Internet users at homes have accessed the Internet through broadband networks and have enjoyed distribution services of digital content including video and music. Home networks with wireless local area networks (LAN), for sharing Internet access by multiple personal computers, also have spread. A lot of digital content has been provided at homes in, for example, music compact discs (CD), liquid-crystal televisions, hard-disk recorders, digital cameras, and digital video cameras.

In these environments, this digital content may not only be used through dedicated equipment for the digital content but interchangeably be used through other consumer electronics (CE) connected to networks, for example, personal computers, audio-visual (AV) equipment, personal digital assistants (PDA), and mobile phones. As is disclosed in Japanese Unexamined Patent Application Publication No. 2002-351759, a possible way to interchangeably use the digital content is streaming of the digital content in the form of an Internet Protocol (IP) packet, which is officially called an IP datagram.

In this case, a unit sending the digital content functions as a server, and another unit receiving the digital content functions as a client. In general, user authentication is required for the streaming transmission of the digital content between the server and the client in the form of an IP packet.

Subjects of the user authentication are digital content, such as music copied from CDs, moving pictures of analog terrestrial broadcast, and moving pictures and still pictures privately recorded with, for example, digital cameras. Purposes of the user authentication include privacy protection and copyright protection.

The server must be provided with Media Access Control (MAC) address filtering so that only pre-registered clients have permission for accessing the digital content and for streaming the digital content. The maximum number of clients that can be registered in the server is limited.

Instead of a MAC address, a nickname given to a client may be used to determine the client registered in a server. In general, since the nickname and the MAC address are not indicated on a client unit, users request the client to display the nickname and the MAC address.

Correspondent authentication is required in a communication through non-secure networks. The correspondent authentication is carried out by checking the MAC address of the correspondent at every communication with reference to the MAC addresses of authorized equipment which are stored in advance. In this case, a system for authorizing the correspondents and receiving the MAC addresses from the authorized equipment is required to store the MAC addresses of the authentic correspondents.

This system is implemented by an “equipment-registration process”, which enables minimized user operations and does not register non-authentic correspondents. In the equipment-registration process, users function as authorities and issue user signals for authorizing equipment. This process can be implemented by simple means, such as pressing buttons of the equipment.

FIG. 6 shows steps in the equipment-registration process when a client 10 is registered in a server 20. Manual registration or automated registration can be selected. In this instance, the manual registration is described as follows:
S1: A user requests the client 10 to submit a registration request to the server 20.
S2: The client 10 presents various kinds of information to the user in response to step S1.
S3: The client 10 sends its own MAC address and submits the registration request of the MAC address to the server 20. The registration request is repeated for a predetermined time.
S4: The user requests the server 20 to accept the registration request in step S3.
S5: The server 20 presents various kinds of information to the user in response to step S4.
S6: When steps S1 to S5 are successfully completed, the server 20 registers the MAC address sent in step S3, in a registration table, the MAC address being an identification code for authenticating the client 10.

In steps S1 to S6, information necessary for the user operation is presented on a display.

Referring to FIG. 7, three clients 10A, 10B, and 10C are registered in the server 20. In this case, steps S to S6 are carried out between the server 20 and the client 10A to register the MAC address MAC_A of the client 10A in the server 20. Similarly, steps S1 to S6 are carried out between the server 20 and the client 10B to register the MAC address MAC_B of the client 10B, and between the server 20 and the client 10C to register the MAC address MAC_C of the client 10C.

After the registration, the server can authenticate the client and send the client the digital content by streaming transmission in the form of an IP packet when a client requests the server to send digital content.

The registration entries of the clients remain in the server even if the clients are inactive. Thus, the client registration entries increase, and the user must delete some clients before the number of registered clients reaches the maximum number of clients that can be registered in the server.

The user may delete the clients after confirming that the deletion operation does not cause a problem. Alternatively, the user may re-register necessary clients after having deleted all the registered clients. However, these operations are complicated, especially when the clients registered by manual registration are deleted by mistake.

### SUMMARY OF THE INVENTION

Accordingly, an object of the present invention is to provide a solution to the above-described problems.

The present invention provides a server apparatus including a registration table for storing identification codes and access times of clients; a registration-controlling unit for controlling the identification codes in the registration table; an authenticating unit for authenticating the clients with reference to the registration table; and a clock for providing a current access time. When one of the clients submits a registration request, the registration-controlling unit registers the identification code of the client and the current access time in the registration table. When one of the clients submits an access request and when the authenticating unit confirms existence of the identification code of the client in the registration table, the access request is accepted and the access time of the client in the registration table is updated with the current access time. At least one client having no access for a predetermined period is removed by deleting the identification code of the client from the registration table.

According to the present invention, a user is free from complicated operations, for example, searching clients subject to deletion and deleting identification codes including a MAC address after confirmation, or re-registering only valid clients after deleting all the clients.

### BRIEF DESCRIPTION OF THE DRAWINGS

FIG. 1 is a system diagram illustrating an embodiment according to the present invention;

FIGS. 2A and 2B are layouts of registration tables in the present invention;

FIG. 3 is a sequence diagram illustrating an embodiment according to the present invention;

FIGS. 4 and 5 are sequence diagrams illustrating another embodiment according to the present invention; and

FIGS. 6 and 7 are sequence diagrams illustrating the present invention.

### DESCRIPTION OF THE PREFERRED EMBODIMENTS

Manual Registration of Clients

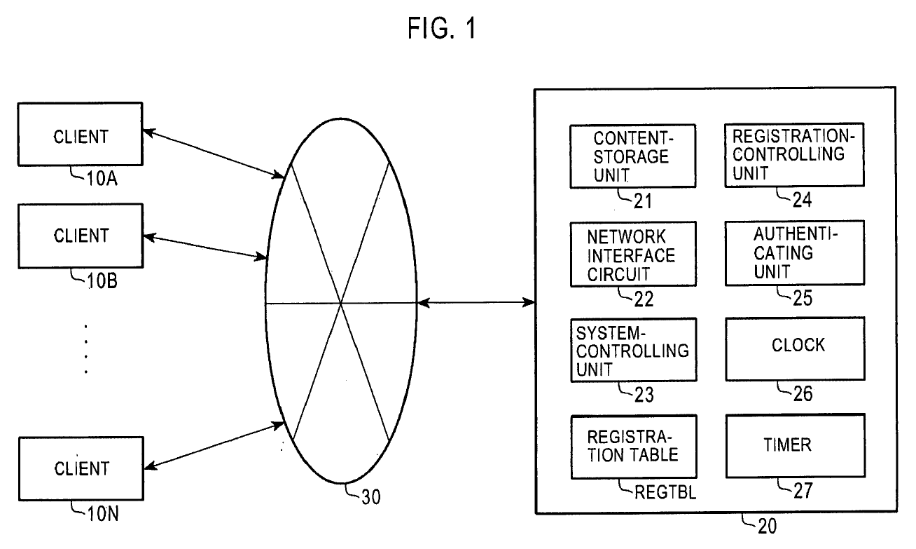

FIG. 1 shows an embodiment of client/server systems according to the present invention. In this embodiment, a user manually registers clients in a server. A network 30, for example, a home LAN, includes clients 10A, 10B, . . . , 10N connected to a server 20.

The server 20 includes a content-storage unit 21, a network interface circuit 22, and a system-controlling unit 23. In this case, the content-storage unit 21 is, for example, a hard disk drive (HDD) and stores digital content such as music and moving pictures, which are distributed by streaming transmission. The network interface circuit 22 connects the clients 10A through 10N to the server 20 based on, for example, Transmission Control Protocol/Internet Protocol (TCP/IP) for transmitting the digital content in the form of an IP packet.

The system-controlling unit 23 includes a computer having central processing units (CPU) and user interfaces, not shown in the drawing. The system-controlling unit 23 controls operations of the content-storage unit 21, the network interface circuit 22, and other units which will be described below; and controls overall operations of the server 20.

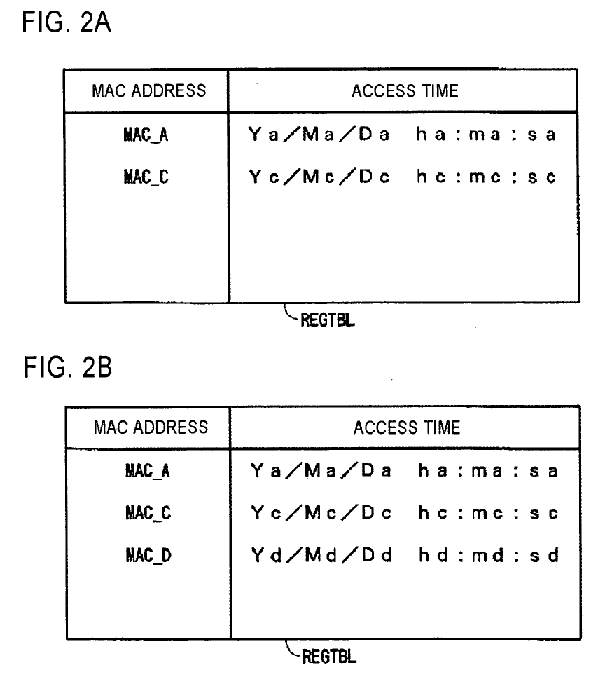

The server 20 includes a registration-controlling unit 24 and an authenticating unit 25. The registration-controlling unit 24 controls the MAC addresses of the clients 10A to 10N in a registration table REGTBL shown in FIG. 2A. When the clients are registered, the MAC addresses and the access times, i.e., the registration times, of the clients are stored in the registration table REGTBL. FIG. 2A shows the registration table REGTBL which stores the MAC addresses MAC_A and MAC_C, and the access times of the clients 10A and 10C, respectively.

The authenticating unit 25 authenticates the clients with reference to the MAC addresses controlled by the registration-controlling unit 24. In this embodiment, the registration-controlling unit 24 and the authenticating unit 25 are programs which are executed on the computer included in the system-controlling unit 23.

The server 20 includes a clock 26 and a timer 27. The clock 26 is the same as that built in a general server and measures date and time, and the timer 27 measures a predetermined interval τ, which is, for example, several minutes. Actually, the timer 27 is a program which is executed on the computer included in the system-controlling unit 23.

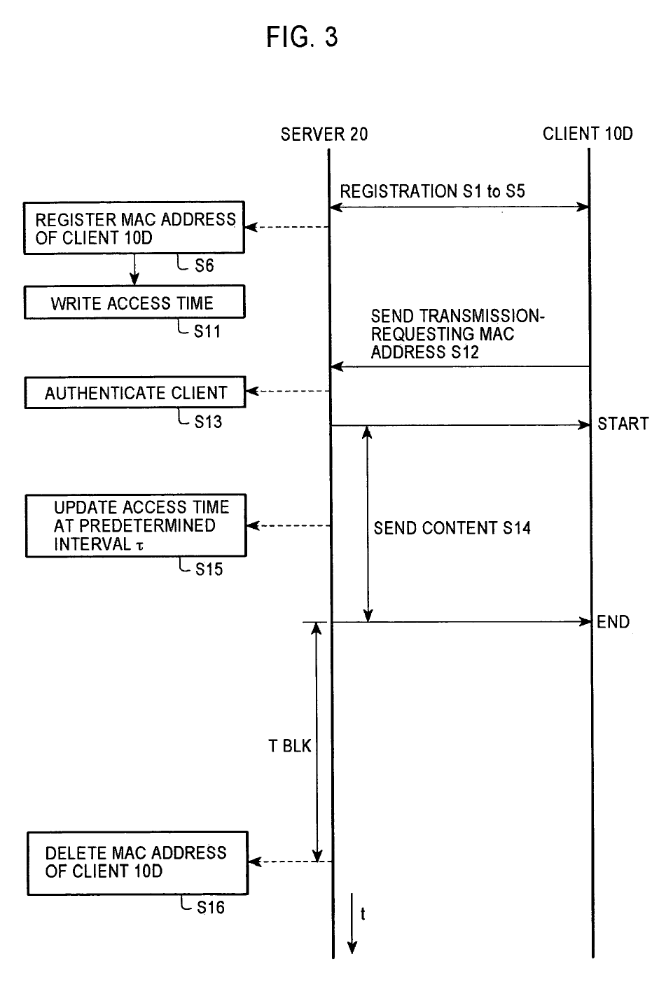

In the above configuration, for example, when the client 10D is not registered and is to be manually registered in the server 20, the client 10D will be registered in the server 20 by connecting the client 10D to the server 20 through the network 30 and executing steps S1 to S6 as shown in FIG. 3.

The registration-controlling unit 24 writes the MAC address MAC_D of the client 10D to the registration table REGTBL shown in FIG. 2B to complete the registration in step S6, and also writes current date and time provided by the clock 26 to the registration table REGTBL as access time, in step S11 in FIG. 3.

When the client 10D requests the server 20 to send the digital content in the form of an IP packet, the MAC address MAC_D of the client 10D is sent to the server 20 as shown in step S12 in FIG. 3. The authenticating unit 25 checks existence of the MAC address MAC_D in the registration table REGTBL as shown in step S13 in FIG. 3.

When the client 10D is not registered, the request from the client 10D for sending the digital content is disregarded. When the client 10D is registered in the server 20, the requested digital content can be retrieved from the content-storage unit 21 and sent to the client 10D as shown in step S14 in FIG. 3.

The server 20 updates the access time of the client 10D in the registration table REGTBL at an interval τ provided by the timer 27 as shown in step S15 in FIG. 3 during sending the client 10D the digital content.

Steps S12 to S15 are carried out whenever any registered client requests the server 20 to send the digital content and the server 20 sends the client the digital content.

The server 20 checks whether a predetermined period TBLK, which is, for example, one month, has elapsed from the last access time of the client 10D by comparing the access time, which is the last updated time, of the client 10D stored in the registration table REGTBL with a current time provided by the clock 26.

When the period TBLK has elapsed, the server 20 deletes the MAC address MAC_D of the client 10D registered in the registration table REGTBL and removes the registration of the client 10D as shown in step S16 in FIG. 3. In this case, the content of the registration table REGTBL is as shown in FIG. 2A.

Similarly, the server 20 also checks other clients registered in the registration table REGTBL. That is, when the predetermined period TBLK has elapsed from the last access times of some of those clients, the server 20 deletes the MAC addresses of the clients from the registration table REGTBL and removes the registrations of the clients.

In the above system, when a client has not accessed the server 20 for the predetermined period TBLK, the server 20 removes the registration of the client in the server 20. Thus, an increase in registered clients in the server can be suppressed. In this case, registered clients are automatically deleted, and the user is free from complicated operations. Besides, special hardware installation is not required in the server 20 and the clients 10A to 10N.

In the above system, the server 20 updates the access time of the client at the interval T as shown in step S15 during the transmission of the digital content to a client by the server 20. Alternatively, the updated access time of the client may be either a start time or an end time of sending the digital content.

In the above system, the MAC addresses of those clients which have no access to the server 20 for the predetermined period TBLK are unconditionally deleted from the registration table REGTBL in step S16. The system can also be set up so as to acquire an approval on the deletion from the user on a confirmation screen presented to the user. When the number of registered clients in the server 20 reaches a predetermined value, those clients which have no access for the period TBLK may be deleted. Instead of a MAC address, a nickname, for example, can be used as an identification code for identifying the clients.

Automated Registration of Clients

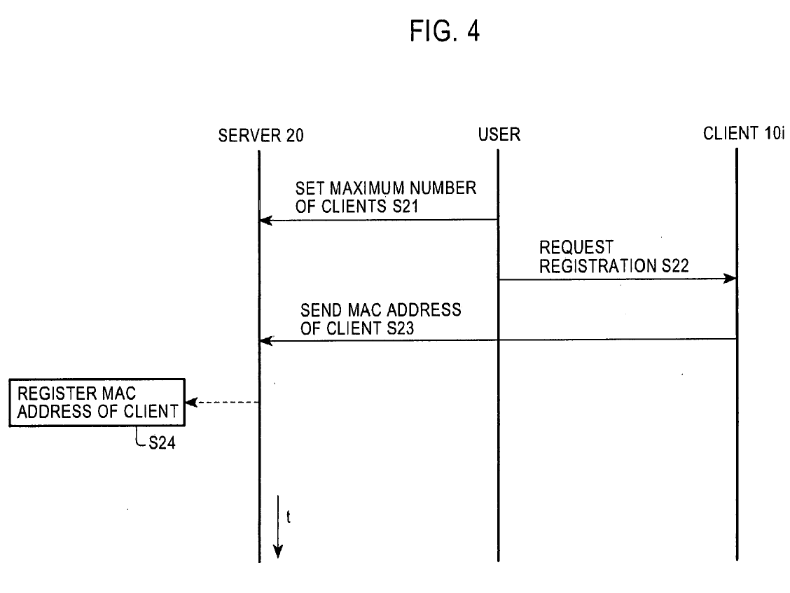

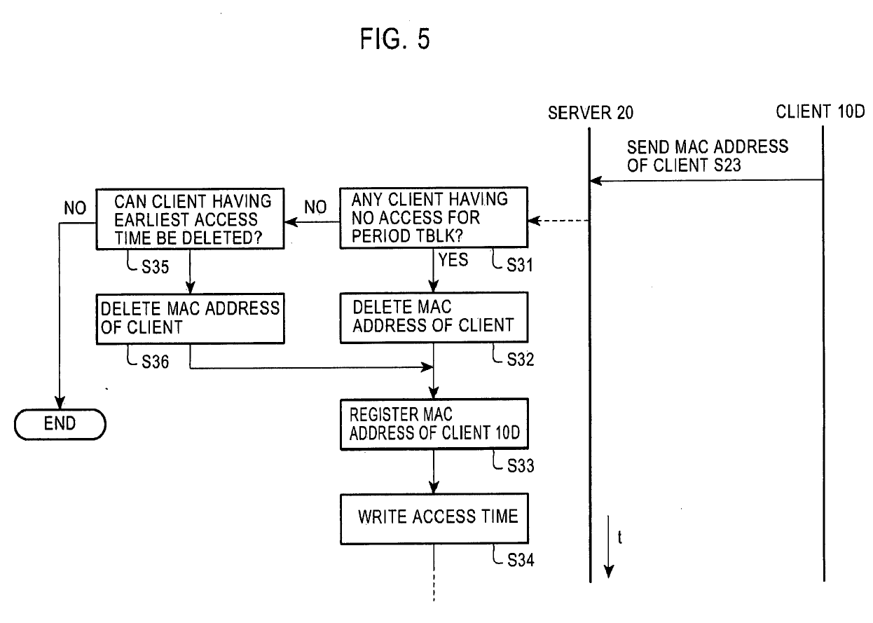

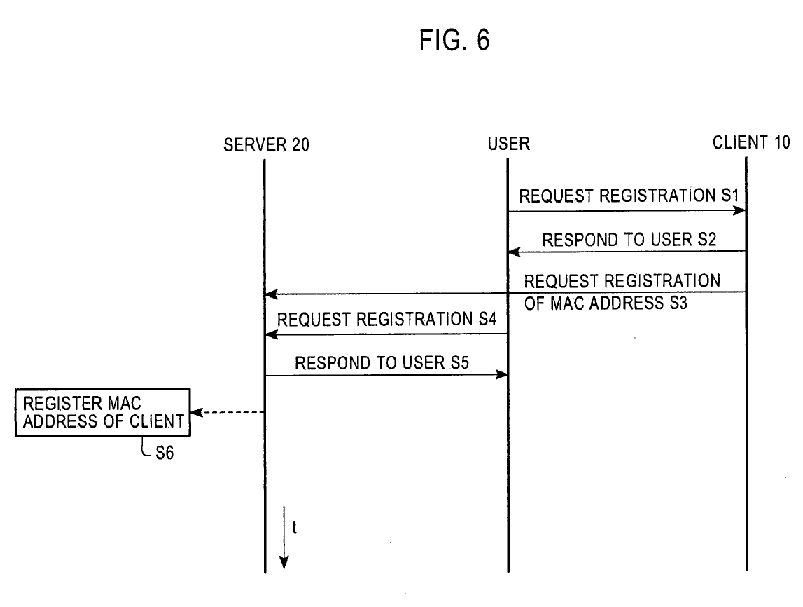

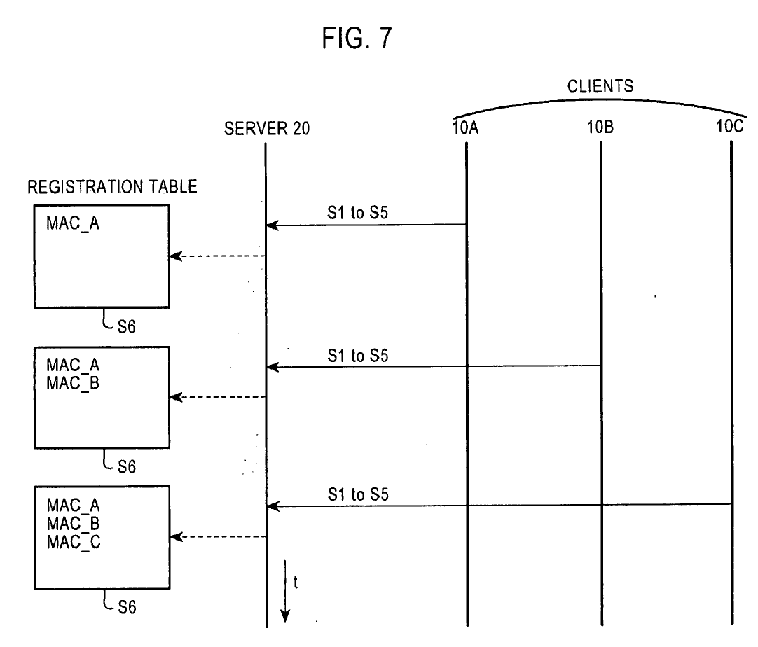

FIGS. 4 and 5 show processes of registration and deletion in another embodiment according to the present invention. In this embodiment, clients are automatically registered in a server. The structures of the network 30 and the server 20 are the same as those in FIG. 1. The registration-controlling unit 24 controls the registration table REGTBL shown in FIG. 2A and the maximum number Cₘₐₓ of clients that can be registered in the server 20.

Referring to FIG. 4, a user accesses the server 20 and sets the maximum number Cₘₐₓ in the server 20 in step S21. When the user operates any client 10i where i=A to N in step S22, the MAC address MAC_i of the client 10i is sent to the server 20 in step S23 and registered in the registration table REGTBL in step S24. A current time provided by the clock 26 is also written to the registration table REGTBL as the access time.

In this way, any client 10i can be registered in the server 20. Other clients can also be registered in the server 20. When the number of registered clients reaches the maximum number Cₘₐₓ controlled by the registration-controlling unit 24, the user can reset the maximum number Cₘₐₓ. However, the maximum number Cₘₐₓ cannot exceed the invariable upper limit Cₗᵢₘ set to the server 20, i.e., Cₗᵢₘ≧Cₘₐₓ.

Referring to FIG. 5, when the number of registered clients in the server 20 reaches the upper limit Cₗᵢₘ, registrations of some clients considered to be needless are deleted. That is, when the number of registered clients in the server 20 reaches the upper limit Cₗᵢₘ upon registering, for example, the client 10D after step S23, the server 20 searches the access times which are the last updated times in the registration table REGTBL for clients having no access for a predetermined period TBLK in step S31.

When the clients are found, a client having the earliest access time among the clients is deleted from the registration table REGTBL in step S32. Then, the MAC address MAC_D of the client 10D having accessed in step S23 is written to the registration table REGTBL in step S33, and the access time is written to the registration table REGTBL in step S34. When no clients are found, the user is inquired whether the client having the earliest access time can be deleted in step S35.

When the user permits the deletion, the client having the earliest access time is removed by deleting the MAC address of the client from the registration table REGTBL in step S36. Then, the MAC address MAC_D and the access time of the client 10D having accessed in step S23 are written to the registration table REGTBL in steps S33 and S34, respectively. When the user does not permit the deletion in response to the inquiry in step S35, the client 10D is not registered.

Accordingly, in the automated registration, an increase in registered clients in the server can be suppressed. The clients are automatically deleted, and the user is free from complicated operations. Besides, special hardware installation is not required in the server 20 and the clients 10A to 10N.

In the above process, the client having the earliest access time may be removed by deleting the MAC address of the client from the registration table REGTBL in step S31. The user may be inquired whether the client having the earliest access time can be deleted in step S32, and the server 20 may follow the user response. Instead of a MAC address, a nickname, for example, may be used as an identification code for identifying the clients.

In the above description, though the manual registration and the automated registration of the clients in the server are separately described, these registrations can be used in combination. In this case, a registration table for the automated registration and a registration table for the manual registration can be separately used, or a single registration table can be used for these two registrations.

1. A server apparatus comprising:
a registration table for storing identification codes and access times of clients;
a registration-controlling unit for controlling the identification codes in the registration table;
an authenticating unit for authenticating the clients with reference to the registration table; and
a clock for providing a current access time, wherein
when one of the clients submits a registration request, the registration-controlling unit registers the identification code of the client and the current access time in the registration table;
when one of the clients submits an access request and when the authenticating unit confirms existence of the identification code of the client in the registration table, the access request is accepted and the access time of the client in the registration table is updated with the current access time; and
at least one client having no access for a predetermined period is removed by deleting the identification code of the client from the registration table.

2. The server apparatus according to claim 1, wherein when the number of registered clients reaches a predetermined value upon checking the number of clients registered in the registration table in response to the access request from the client, at least one client having no access for the predetermined period is removed by deleting the identification code of the client from the registration table.

3. A server apparatus comprising:
a registration table for storing identification codes and access times of clients;
a registration-controlling unit for controlling the identification codes in the registration table;
an authenticating unit for authenticating the clients with reference to the registration table; and
a clock for providing a current access time, wherein
when the number of clients registered in the registration table does not reach a predetermined value upon checking the number of clients registered in the registration table in response to a registration request from one of the clients, the registration-controlling unit registers the identification code of the client and the current access time in the registration table;
when the number of clients registered in the registration table reaches the predetermined value upon the checking, the identification codes of the clients which have not accessed for a predetermined period since the last access time are searched by comparing the access times registered in the registration table with the current access time, and at least one client among the clients is removed by deleting the identification code of the client and the registration-controlling unit registers the identification code of the client having submitted the registration request and the current access time in the registration table.
